(19) United States
(12) Patent Application Publication
(10) Pub. No.: US 2008/0177719 A1
(43) Pub. Date: Jul. 24, 2008

(54) METHODS AND SYSTEMS FOR RETRIEVING QUERY RESULTS BASED ON A DATA STANDARD SPECIFICATION

(76) Inventors: Richard Dean Dettinger, Rochester, MN (US); Daniel Paul Kolz, Rochester, MN (US); Frederick Allyn Kulack, Rochester, MN (US); Shannon Everett Wenzel, Colby, WI (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(21) Appl. No.: 11/626,459

(22) Filed: Jan. 24, 2007

(51) Int. Cl. G06F 17/30

(52) U.S. Cl. 707/4; 707/E17.014

(57) ABSTRACT

Data standards are defined for data according to various criteria. A data standard may be selected for an abstract query, wherein the data standard identifies a quality of data. A query may be generated based on the abstract query and the selected data standard, wherein the query is configured to retrieve results of the abstract query that are in accordance with the selected data standard.

### CROSS-REFERENCE TO RELATED APPLICATIONS

This application is related to U.S. patent application Ser. No. ______, Attorney Docket No. ROC920060235US1, entitled “Methods and Systems for Displaying Standardized Data”, filed herewith, by Dettinger, et al. This related patent application is herein incorporated by reference in its entirety.

### BACKGROUND OF THE INVENTION

1. Field of the Invention

The present invention is generally related to data processing, and more specifically to retrieving data from a database.

2. Description of the Related Art

Databases are computerized information storage and retrieval systems. A relational database management system is a computer database management system (DBMS) that uses relational techniques for storing and retrieving data. The most prevalent type of database is the relational database, a tabular database in which data is defined so that it can be reorganized and accessed in a number of different ways. A distributed database is one that can be dispersed or replicated among different points in a network. An object-oriented programming database is one that is congruent with the data defined in object classes and subclasses.

Regardless of the particular architecture, in a DBMS, a requesting entity (e.g., an application or the operating system) demands access to a specified database by issuing a database access request. Such requests may include, for instance, simple catalog lookup requests or transactions and combinations of transactions that operate to read, change and add specified records in the database. These requests are made using high-level query languages such as the Structured Query Language (SQL) and application programming interfaces (API's) such as Java® Database Connectivity (JDBC). The term “query” denominates a set of commands for retrieving data from a stored database. Queries take the form of a command language, such as SQL, that lets programmers and programs select, insert, update, find the location of data, and so forth.

Any requesting entity, including applications, operating systems and, at the highest level, users, can issue queries against data in a database. Queries may be predefined (i.e., hard coded as part of an application) or may be generated in response to input (e.g., user input). Upon execution of a query against a database, a query result is returned to the requesting entity.

For example, a medical researcher may issue queries against a database to retrieve data to support research efforts. The data may include, for example, patient records that may be used to determine the pathology for particular disorders. Patient records may include, for example, a patients' demographic data, values for administered tests, testing conditions, patient response to tests, doctor's notes, and the like. Studying the data related to a particular disorder stored in a database may allow researchers to devise adequate measures to improve prevention, diagnosis, and management of the disorder.

One problem with retrieving data for medical research is that not all data retrieved by a query may be desirable. For example, a researcher may collect data for his research from a number of sources, for example, from one or more hospitals. If a hospital does not have reliable procedures for data collection, the data may be unreliable, and therefore undesirable for inclusion in the research. For example, a hospital may use outdated equipment for conducting tests on a patient, thereby making that hospital's data unreliable and undesirable for research purposes.

Any given database may also contain invalid data that can be returned in a given query result, such as negative age values. The invalid data can be introduced into a given database due to various reasons, such as typographical errors, architectural problems with data replication and timing, mistakes in original data acquisition, and the like. Because of the invalid data, the given query result can be useless to a corresponding requesting entity that wants to further process the query result. For instance, if the researcher wants to determine an average age of patients in a hospital for which a specific treatment is suitable and the query result includes negative age values, an incorrect average value is obtained. Accordingly, some level of data cleansing is needed to ensure data consistency, accuracy, and reliability in a given database.

However, in large databases data cleansing is an expensive and time-consuming process that may require a large amount of processor resources and an even larger amount of manpower. Accordingly, data cleansing is not automatically implemented and/or frequently performed in database environments and, as a result, corresponding databases may include undesirable or invalid data. Thus, a user needs to perform a manual clean operation on each query result obtained from such a database in order to identify invalid data included therewith prior to further processing of the query result. More specifically, the user needs to perform an exhaustive examination on any data returned from the database in order to verify whether the data is valid or to execute suitable database queries that are configured to identify whether the database includes the invalid data.

Accordingly, what is needed are methods, systems, and articles of manufacture for retrieving data based on a quality of the data.

### SUMMARY OF THE INVENTION

The present invention is generally related to data processing, and more specifically to retrieving data from a database.

One embodiment of the invention provides a method for retrieving results from a database. The method generally comprises selecting a data standard to be applied to a query, wherein the data standard identifies a quality of data, the data standard being selected from at least two different data standards, generating the query based on the selected data standard, wherein the query is configured to retrieve results that are in accordance with the selected data standard, and executing the query.

Another embodiment of the invention provides a computer readable medium containing a program which, when executed, performs an operation generally comprising receiving a data standard selection to be applied to a query, wherein the data standard identifies a quality of data, the data standard being selected from at least two different data standards, generating the query based on the selected data standard, wherein the query is configured to retrieve results that are in accordance with the selected data standard, and executing the query.

Yet another embodiment of the invention provides a system generally comprising at least a memory and a processor. The system further comprises a data abstraction model providing a definition for each of a plurality of logical fields and a data standard definition for each of the logical fields, wherein the data standard definitions include at least two different data standard definitions defined on the basis of respective criteria, and a run time component for generating, from an abstract query referencing at least one of the logical fields, a query consistent with a particular physical representation of data, wherein the query is configured to retrieve results that are consistent with the data standard definition corresponding to the at least one logical field referenced by the abstract query.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments thereof which are illustrated in the appended drawings.

It is to be noted, however, that the appended drawings illustrate only typical embodiments of this invention and are therefore not to be considered limiting of its scope, for the invention may admit to other equally effective embodiments.

FIG. 1 illustrates an exemplary system according to an embodiment of the invention.

FIG. 2 illustrates a relational view of software components used to create and execute database queries, according to an embodiment of the invention.

FIG. 3 illustrates a data abstraction model according to an embodiment of the invention.

FIG. 4 illustrates an exemplary Graphical User Interface (GUI) screen for composing a query, according to an embodiment of the invention.

FIG. 5 illustrates another exemplary GUI screen for composing a query, according to an embodiment of the invention.

FIG. 6 illustrates yet another exemplary GUI screen for composing a query, according to an embodiment of the invention.

FIG. 7 illustrates an exemplary GUI screen for specifying a data standard, according to an embodiment of the invention.

FIG. 8 illustrates an exemplary data table against which a query according to an embodiment of the invention may be executed.

FIG. 9 is a flow diagram of exemplary operations performed to compose and execute a query, according to an embodiment of the invention.

### DETAILED DESCRIPTION OF THE PREFERRED EMBODIMENTS

The present invention is generally related to data processing, and more specifically to retrieving data from a database. A data standard may be selected for an abstract query, wherein the data standard identifies a quality of data. A query may be generated based on the abstract query and the selected data standard, wherein the query is configured to retrieve results of the abstract query that are in accordance with the selected data standard.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

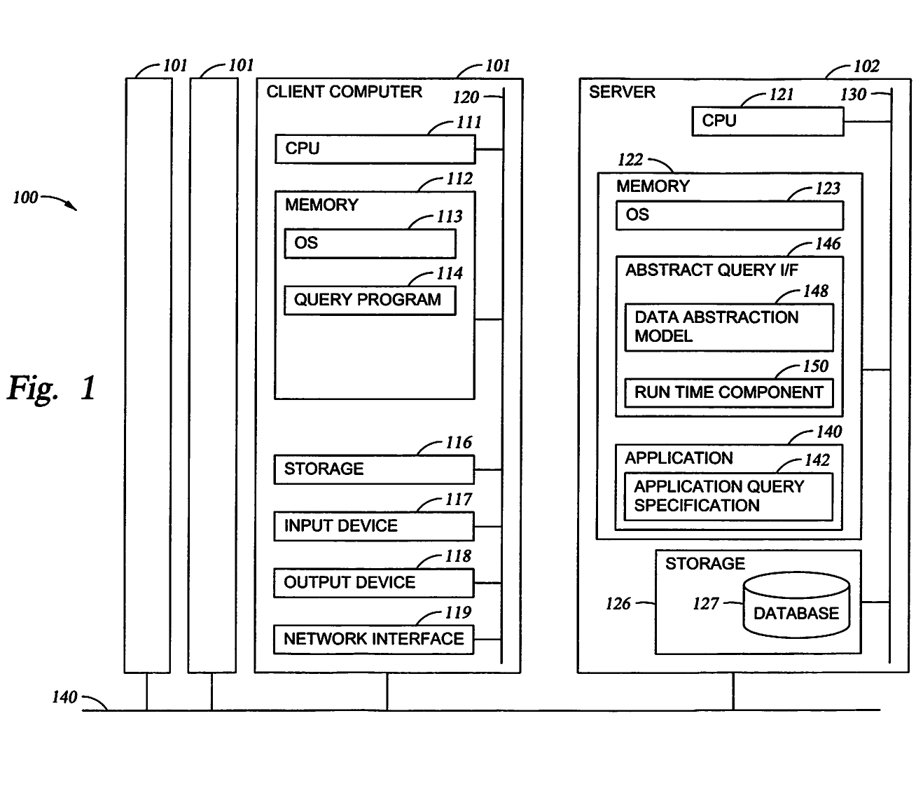

One embodiment of the invention is implemented as a program product for use with a computer system such as, for example, the network environment 100 shown in FIG. 1 and described below. The program(s) of the program product defines functions of the embodiments (including the methods described herein) and can be contained on a variety of computer-readable media. Illustrative computer-readable media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); and (iii) information conveyed to a computer by a communications medium, such as through a computer or telephone network, including wireless communications. The latter embodiment specifically includes information downloaded from the Internet and other networks. Such computer-readable media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

### Exemplary System

FIG. 1 depicts a block diagram of a networked system 100 in which embodiments of the invention may be implemented. In general, the networked system 100 includes a client (e.g., user's) computer 101 (three such client computers 101 are shown) and at least one server 102 (one such server 102 shown). The client computers 101 and server 102 are connected via a network 140. In general, the network 140 may be a local area network (LAN) and/or a wide area network (WAN). In a particular embodiment, the network 140 is the Internet.

The client computer 101 includes a Central Processing Unit (CPU) 111 connected via a bus 120 to a memory 112, storage 116, an input device 117, an output device 118, and a network interface device 119. The input device 117 can be any device to give input to the client computer 101. For example, a keyboard, keypad, light-pen, touch-screen, track-ball, or speech recognition unit, audio/video player, and the like could be used. The output device 118 can be any device to give output to the user, e.g., any conventional display screen. Although shown separately from the input device 117, the output device 118 and input device 117 could be combined. For example, a display screen with an integrated touch-screen, a display with an integrated keyboard, or a speech recognition unit combined with a text speech converter could be used.

The network interface device 119 may be any entry/exit device configured to allow network communications between the client computers 101 and server 102 via the network 140. For example, the network interface device 119 may be a network adapter or other network interface card (NIC).

Storage 116 is preferably a Direct Access Storage Device (DASD). Although it is shown as a single unit, it could be a combination of fixed and/or removable storage devices, such as fixed disc drives, floppy disc drives, tape drives, removable memory cards, or optical storage. The memory 112 and storage 116 could be part of one virtual address space spanning multiple primary and secondary storage devices.

The memory 112 is preferably a random access memory sufficiently large to hold the necessary programming and data structures of the invention. While memory 112 is shown as a single entity, it should be understood that memory 112 may in fact comprise a plurality of modules, and that memory 112 may exist at multiple levels, from high speed registers and caches to lower speed but larger DRAM chips.

Illustratively, the memory 112 contains an operating system 113. Illustrative operating systems, which may be used to advantage, include Linux (Linux is a trademark of Linus Torvalds in the US, other countries, or both) and Microsoft's Windows®. More generally, any operating system supporting the functions disclosed herein may be used.

Memory 112 is also shown containing a query program 114 which, when executed by CPU 111, provides support for issuing queries to server 102. In one embodiment, the query program 114 may include a web-based Graphical User Interface (GUI), which allows the user to display Hyper Text Markup Language (HTML) information. The GUI may be configured to allow a user to create a query, issue the query against a server 102, and display the results of the query. More generally, however, the query program may be a GUI-based program capable of rendering any information transferred between the client computer 101 and the server 102.

The server 102 may by physically arranged in a manner similar to the client computer 101. Accordingly, the server 102 is shown generally comprising at least one CPU 121, memory 122, and a storage device 126, coupled with one another by a bus 130. Memory 122 may be a random access memory sufficiently large to hold the necessary programming and data structures that are located on server 102.

In one embodiment, server 102 may be a logically partitioned system, wherein each logical partition of the system is assigned one or more resources, for example, CPUs 121 and memory 122, available in server 102. Accordingly, server 102 may generally be under the control of one or more operating systems 123 shown residing in memory 122. Each logical partition of server 102 may be under the control of one of the operating systems 123. Examples of the operating system 123 include IBM OS/400®, UNIX, Microsoft Windows®, and the like. More generally, any operating system capable of supporting the functions described herein may be used.

The memory 122 further includes one or more applications 140 and an abstract query interface 146. The applications 140 and the abstract query interface 146 are software products comprising a plurality of instructions that are resident at various times in various memory and storage devices in the computer system 100. When read and executed by one or more processors 121 in the server 102, the applications 140 and the abstract query interface 146 cause the computer system 100 to perform the steps necessary to execute steps or elements embodying the various aspects of the invention.

The applications 140 (and more generally, any requesting entity, including the operating system 123) are configured to issue queries against a database 127 (shown in storage 126). The database 127 is representative of any collection of data regardless of the particular physical representation. By way of illustration, the database 127 may be organized according to a relational schema (accessible by SQL queries) or according to an XML schema (accessible by XML queries). However, the invention is not limited to a particular schema and contemplates extension to schemas presently unknown. As used herein, the term “schema” generically refers to a particular arrangement of data.

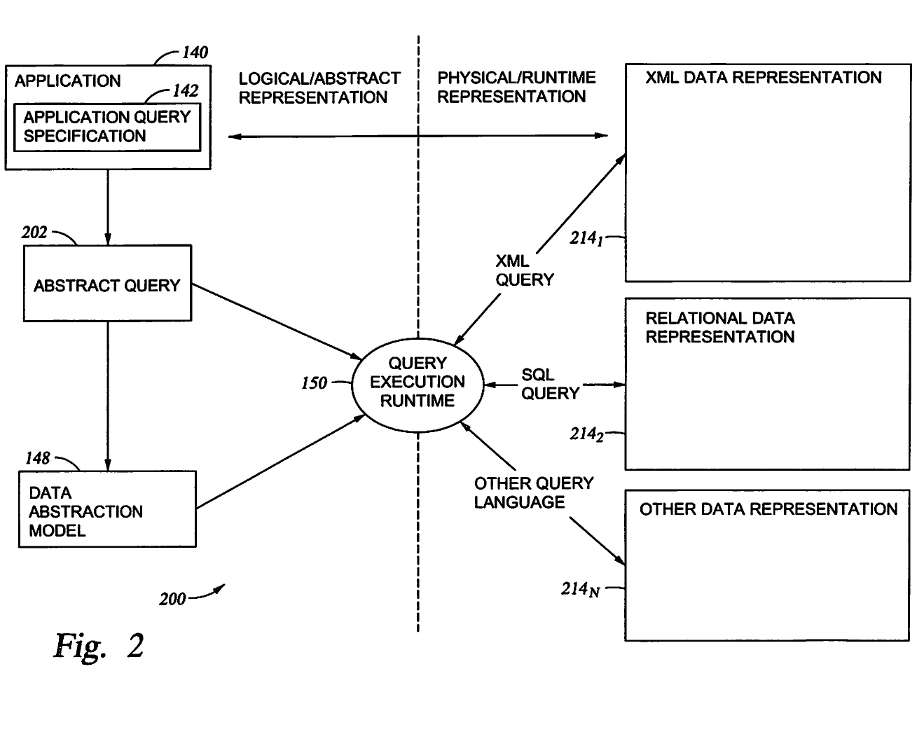

In one embodiment, the queries issued by the applications 140 are defined according to an application query specification 142 included with each application 140. The queries issued by the applications 140 may be predefined (i.e., hard coded as part of the applications 140) or may be generated in response to input (e.g., user input). In either case, the queries (referred to herein as “abstract queries”) are composed using logical fields defined by the abstract query interface 146. In particular, the logical fields used in the abstract queries are defined by a data abstraction model 148 of the abstract query interface 146. The abstract queries are executed by a runtime component 150 which transforms the abstract queries into a form consistent with the physical representation of the data contained in the database 127. The application query specification 142 and the abstract query interface 146 are further described with reference to FIG. 2.

In one embodiment, elements of a query are specified by a user through a graphical user interface (GUI). The content of the GUIs may be generated by the application(s) 140. In a particular embodiment, the GUI content is hypertext markup language (HTML) content which may be rendered on the client computer systems 101 with query program 114. For example, the server 102 may respond to requests to access a database 127, which illustratively resides on the server 102. Incoming client requests for data from the database 127 may invoke an application 140. When executed by the processor 121, the application 140 may cause the server 102 to perform the steps or elements embodying the various aspects of the invention, including accessing database 127.

### Relational View of Environment

FIG. 2 illustrates an exemplary relational view 200 of components according to an embodiment of the invention. A requesting entity, for example, an application 140 may issue a query 202 as defined by the respective application query specification 142 of the requesting entity. The resulting query 202 is generally referred to herein as an “abstract query” because the query is composed according to abstract (i.e., logical) fields rather than by direct reference to the underlying physical data entities in the database 127. As a result, abstract queries may be defined that are independent of the particular underlying data representation used. In one embodiment, the application query specification 142 may include both criteria used for data selection and an explicit specification of the fields to be returned based on the selection criteria.

The logical fields specified by the application query specification 142 and used to compose the abstract query 202 are defined by the data abstraction model 148. In general, the data abstraction model 148 may expose information as a set of logical fields that may be used within a query (e.g., the abstract query 202) issued by the application 140 to specify criteria for data selection and specify the form of result data returned from a query operation. The logical fields may be defined independently of the underlying data representation being used in the database 127, thereby allowing queries to be formed that are loosely coupled to the underlying data representation.

In one embodiment of the invention, abstract query 202 may include a query attribute selection to determine a data standard of data retrieved from database 127. The data standard may determine a quality of the data retrieved for the query. For example, one or more data standards may be defined in the data abstraction model 148 to distinguish data stored in a database based on one or more criteria. Exemplary data standards may include, for example, gold standard, silver standard, no standard, and the like. In one embodiment, gold standard data may be highly desirable data due to, for example, high reliability and accuracy of the data.

For example, gold standard data may represent test data collected in a highly controlled environment and/or using superior equipment, and the like. Therefore, determining whether data is gold may involve determining whether the data falls within a definition of gold data. For example, the definition of gold data may include environmental conditions, equipment types, time of data collection, and the like.

Silver standard data may be less desirable than gold standard data because of, for example, the lack of a controlled test environment during data collection, use of inferior equipment, and the like. Accordingly, silver data may be data that does not qualify a gold data. In some embodiments, silver data may be data that satisfies a definition of silver data. The definition of silver data may include, for example, environmental conditions, test equipment, time of data collection, and the like.

In one embodiment, no standard data may be data for which criteria establishing the data standard are not available. For example, no standard data may be data for which one or more definitional criteria, for example, environmental conditions, test equipment, time of collection, and the like is not available. Alternatively, no standard data may be selected if a particular data standard is not desired in the query results. For example, in one embodiment a user may desire to retrieve results irrespective of the data standard. Accordingly, the user may select no-standard as the data standard. While gold standard data, silver standard data, and no standard data are described herein, one skilled in the art will recognize that any number of levels of data standards may be implemented.

Furthermore, any reasonable criteria for establishing data standards may be implemented. In one embodiment, one or more values of particular fields in database 127 may establish the data standard. For example, it may be desirable to consider test data collected in a particular temperature range or using a particular measuring device. Accordingly, the definition of gold standard data in the data abstraction model 148 may include the particular temperature range and/or the particular measuring device. Data falling outside the temperature range and/or data collected with an inferior measuring device may be classified as silver standard data. Data for which the temperature or equipment data is unavailable may be classified as no standard data.

In one embodiment of the invention, the date of data collection may determine the data standard. For example, a hospital may induct new test equipment for data collection on a particular date. The new test equipment may be superior to previously used equipment. Accordingly, data collected after the date of induction of the new test equipment may be classified as gold standard data. Data collected using the previously used equipment may be classified as silver standard data.

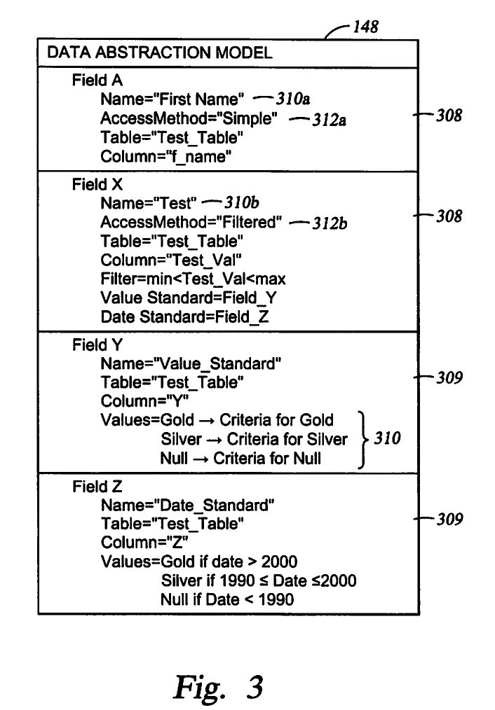

FIG. 3 illustrates an exemplary data abstraction 148 model according to an embodiment of the invention. In general, data abstraction model 148 comprises a plurality of field specifications 308. A field specification may be provided for each logical field available for composition of an abstract query. Each field specification may comprise a logical field name 310 and access method 312. For example, the field specification for Field A in FIG. 3 includes a logical field name 310a (‘FirstName’), and an associated access method 312a (‘simple’).

The access methods may associate logical field names 310 to a particular physical data representation 214 (See FIG. 2) in a database 127. By way of illustration, two data representations are shown in FIG. 2, an XML data representation 214₁, and a relational data representation 214₂. However, the physical data representation 214_{N} indicates that any other data representation, known or unknown, is contemplated. In one embodiment, a single data abstraction module 148 may contain field specifications with associated access methods for two or more physical data representations 214. In an alternative embodiment, a separate data abstraction module 148 may be provided for each separate data representation 214.

Any number of access methods is contemplated depending upon the number of different types of logical fields to be supported. In one embodiment, access methods for simple fields, filtered fields and composed fields are provided. For example, field specifications for Field A exemplify a simple field access method 312a. Simple fields are mapped directly to a particular entity in the underlying physical data representation (e.g., a field mapped to a given database table and column). By way of illustration, the simple field access method 312a, shown in FIG. 3 maps the logical field name 310a (‘FirstName’) to a column named “f_name” in a table named “Test Table,” as illustrated.

The field specification for Field X exemplifies a filtered field access method 312b. Filtered fields identify an associated physical entity and provide rules used to define a particular subset of items within the physical data representation. For example, the filtered field access method 312b may map the logical field name 310b to a physical entity in a column named “TestVal” in a table named “Test Table” and may define a filter for the test values. For example, in one embodiment, the filter may define a numerical range in which the test values may be deemed valid.

A composed field access method may also be provided to compute a logical field from one or more physical fields using an expression supplied as part of the access method definition. In this way, information which does not exist in the underlying data representation may be computed. For example, a sales tax field may be composed by multiplying a sales price field by a sales tax rate.

It is contemplated that the formats for any given data type (e.g., dates, decimal numbers, etc.) of the underlying data may vary. Accordingly, in one embodiment, the field specifications 308 may include a type attribute which reflects the format of the underlying data. However, in another embodiment, the data format of the field specifications 308 is different from the associated underlying physical data, in which case an access method is responsible for returning data in the proper format assumed by the requesting entity.

Thus, the access method must know what format of data is assumed (i.e., according to the logical field) as well as the actual format of the underlying physical data. The access method may then convert the underlying physical data into the format of the logical field. By way of example, the field specifications 308 of the data abstraction model 148 shown in FIG. 2 are representative of logical fields mapped to data represented in the relational data representation 2142. However, other instances of the data abstraction model 148 map logical fields to other physical data representations, such as XML.

A field specification 308 may include one or more standard specifications for identifying a data standard. The standard specifications may map to a standard specification field 309 of data abstraction model 148. For example, in FIG. 3, Field X may include a value standard 320 and/or a date standard 321. Value standard 320 may map to a value standard specification field Y and the date standard 321 may map to a date standard specification field Z.

The standard specification fields 309 may include data standard definitions. Illustratively, value standard field Y may define a data standard based on one or more values in particular fields of database 127. For example, in one embodiment, the data standard may depend on a temperature at which data is collected determined by a temperature field of database 127, as discussed above. Accordingly, standard specification Field Y, may define a first temperature range defining gold standard data, a second temperature range defining silver standard data, and the like, as illustrated in FIG. 3. The temperature ranges establishing the data standard may be defined in the criteria 310 of value standard field Y.

One skilled in the art will recognize that any number and types of criteria may establish a particular data standard. In other words, in some embodiments, the data standard may be established by a plurality of fields of database 127. For example, a particular data standard, for example, the gold standard, may be defined based on temperature, pressure, the type of equipment used, and the like. Furthermore, any types of field, for example, numerical, alphabetical, Boolean, time/date type fields may be included in the definition of a particular data standard.

In one embodiment of the invention, a date standard field Z may establish a data standard based on the date of measurement of data. For example, in data standard field Z of FIG. 3, gold standard data is defined as data collected after the year 2000. Silver standard data is defined as data collected between the years 1990 and 2000. Data collected prior to the year 1990 is defined as null or no standard data.

In one embodiment of the invention, the definitions of the date standard field may be associated with the induction of superior equipment for collecting data. For example, a hospital may induct a superior blood pressure monitor in the year 2001. Accordingly, data collected after the year 2000 may be more accurate and more desirable for analysis and research. Therefore data collected after the year 2000 may be defined as gold standard data. Blood pressure data collected prior between 1990 and 2000 may have been collected with older and less desirable equipment. Accordingly, such data may be defined as silver standard data. The nature of equipment used to collect blood pressure data prior to 1990 may not be known. Therefore, such data may be defined as no standard data.

While definition of date standard data based on the induction of new equipment is described herein, one skilled in the art will recognize that any other event or combination of events may establish the data standard based on date. For example, a hospital may induct an improved procedure to collect patient data. The time range of data collection based on a particular procedure may define a particular data standard.

### Retrieving Data Based on Data Standards

In one embodiment of the invention, creating a query may involve providing a graphical user interface for defining the query. For example, a user may launch a query program 114 in client computer 101 to construct a query. Query program 114 may display a plurality of graphical user interface (GUI) screens to aid the user in constructing a query to retrieve desired data from database 127. The graphical user interface screen may include a combination of text boxes, drop down menus, selection buttons, check boxes, and the like, to create query conditions.

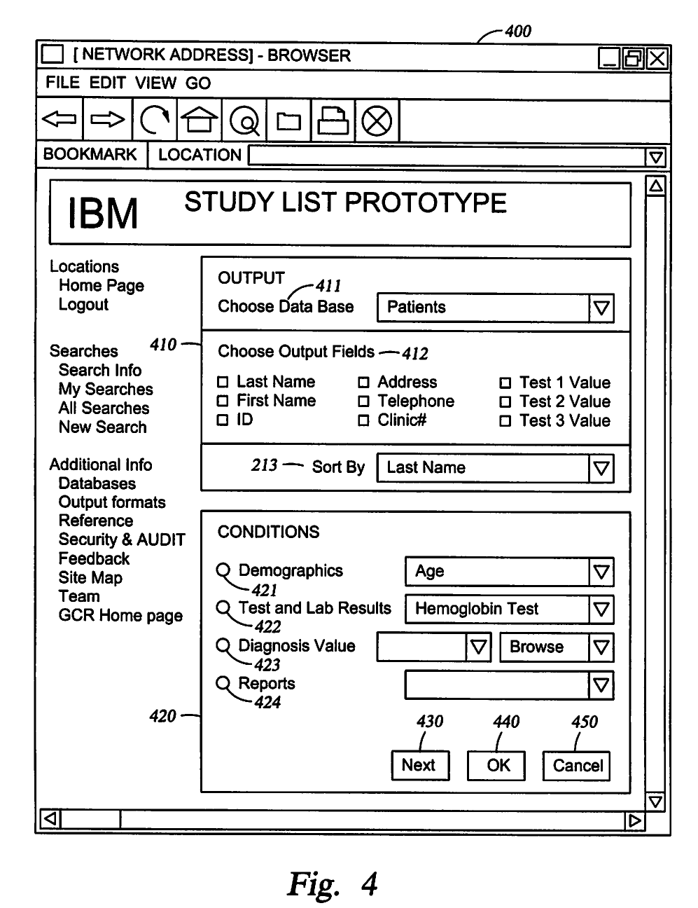

FIG. 4 illustrates an exemplary GUI screen 400 for constructing a query. In general, GUI 400 may include a plurality of output categories 410 and a plurality of condition categories 420. Output categories 410 may contain a choice of database 411 to select a database 127, for example, a database containing data for a particular type of persons related to the hospital. A user may choose for example, in a drop down box, the patients' database, doctors' database, staff database, etc.

Output categories 410 may also contain a list of output fields that may define particular data displayed in the results of a query. Output field selection may be performed by clicking check boxes associated with a listed field. For example, in FIG. 4, checkboxes are provided for selecting Last Name, First Name, Identification number (ID), Address, Telephone number, and Clinic number test 1 value, and the like. While check boxes are described herein, one skilled in the art will recognize that any reasonable means for selecting the output fields, such as a drop down boxes, text boxes, etc may be used.

Output categories 410 may contain a sort drop down box to select a reference field for sorting. Output fields 412 may be provided in the dropdown box. In some embodiments the fields reflected in the sort box 413 may be dynamically updated to reflect only those fields selected by the user. For simplicity, FIG. 4 illustrates the selection of only one field for sorting. However, one skilled in the art will recognize that results may be provided using different sorting criteria for multiple fields. Therefore, GUI 400 may include appropriate GUI elements to receive input related to such multiple fields and sorting criteria.

GUI 400 may also contain a plurality of condition categories 420, each category having an associated radio button that the user may select. The condition categories shown include “demographics” 421, “Tests and Lab Results” 422, “Diagnosis” 423 and “Reports” 424. As illustrated, each field has an associated field into which a value may be selected or input. Some fields are drop down menu's while some may be text boxes. In the latter case, the fields may have associated browse buttons to facilitate user selection of valid values.

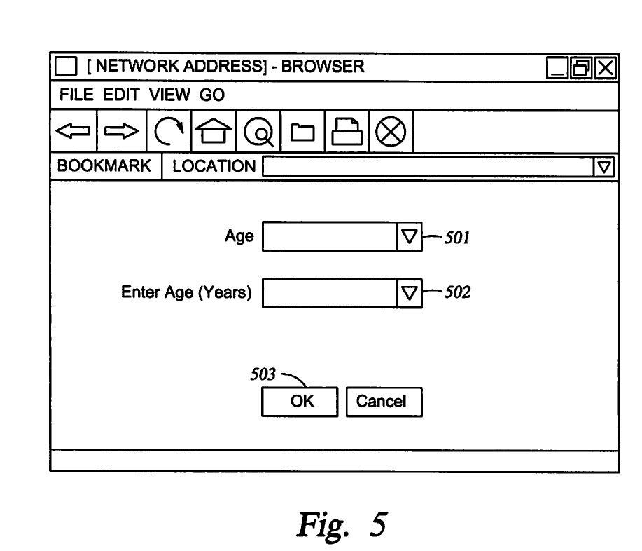

Once the condition categories and values have been selected, the user may click on the Next button 430. Clicking the Next button 430 may cause the GUI to render the next appropriate interface necessary to continue the process of adding a condition. In this manner, the user may be presented with a series of graphical user interfaces necessary to add a condition. By way of example, assume that the user has selected the demographic condition category 421 and the “Age” value from the drop-down menu. Upon pressing the Next button 430, the user may be presented with a second GUI 500 shown in FIG. 5. GUI 500 may comprise a comparison operator drop-down menu 501 from which a user may select a comparison operator (e.g., >, <, =) and an age field 502 into which a user may input a value for the age. The process of adding the age condition is completed when the user clicks on the OK button 503.

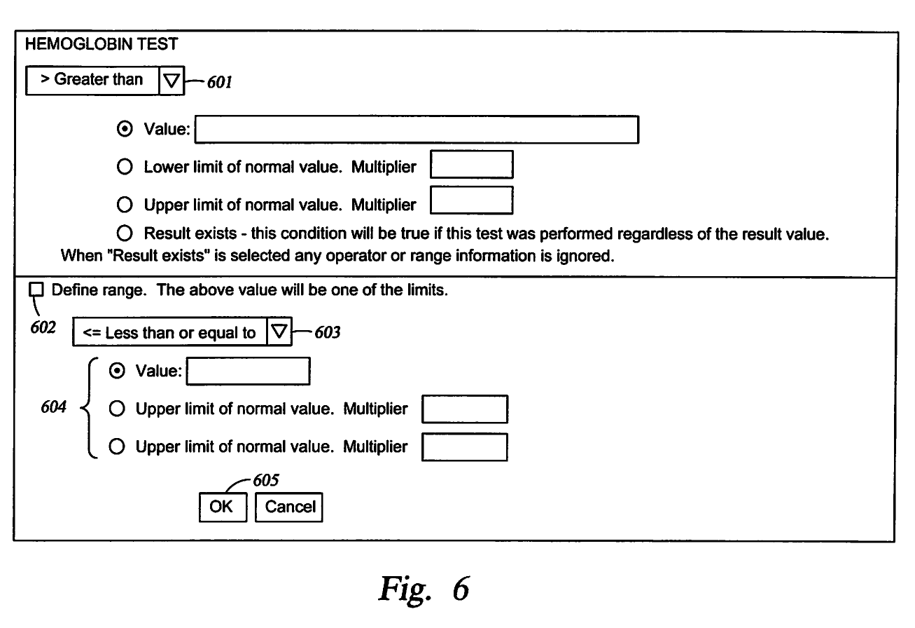

Similarly, if the user had selected Hemoglobin Test in the Tests and Lab Results dropdown 422 GUI 600 in FIG. 6 may be displayed to input desired search criteria for the selected test. The upper portion of the GUI 600 includes a drop-down menu 601 from which to select a comparison operator and a plurality of regular buttons (illustratively for) for defining a value. The user may search on a range of values for the selected test by checking the Range checkbox 602. The user must then specifying a comparison operator from the drop-down menu 603 and an associated value by selecting one of the radio buttons is 604. Once the search criteria for GUI 600 have been entered the user may press the OK button 605.

Shown below is an exemplary query that may be constructed using the GUI screens 400, 500, and 600:

SELECT “Patient ID”, “Last Name”, “Test1”
FROM TABLE PATIENTS
WHERE
Age > 50 AND HemoglobinTest > 30

The SELECT clause of the query may identify the results displayed when the query is run. For example, in the exemplary query above, the patient ID, patients' last name, and Test1 value may be displayed in the results of the query. The contents of the SELECT clause may be determined by user selection of output fields 412 in GUI screen 400.

The FROM clause of the exemplary query may determine the particular database from which results are retrieved. For example, the results are derived from the Patients database in the exemplary query above. The database from which the results are derived may be determined by user selection of the database 411 in GUI screen 400.

The WHERE clause of the exemplary query establishes query conditions. For example, the Age >50 condition may be defined by a user using GUI screen 500 and the Hemoglobin Test >30 condition may be defined by the user using GUI screen 600.

In one embodiment of the invention, the exemplary query described above may be an abstract query. Accordingly, each field of the exemplary query, for example, patient ID, last name, test 1, age, hemoglobin test, and the like, may have an associated field specification 308 (see FIG. 3) in data abstraction model 248. The abstract query may be executed by the runtime component 150 which transforms the abstract queries into a form consistent with the physical representation of the data contained in the database 127 based on data abstraction model 148.

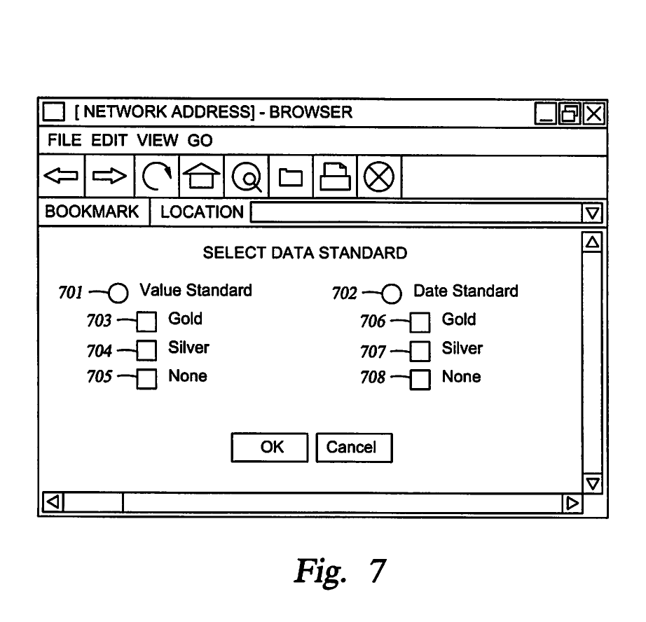

In one embodiment of the invention, after a query is constructed by a user, query application 114 may display a data standard selection GUI 700, illustrated in FIG. 7. GUI 700 may allow a user to select a data standard to be applied to the query. For example, a user executing the exemplary query may only want to retrieve gold standard data. Accordingly, the user may make appropriate selections in GUI 700 to indicate that gold standard data is desired.

As illustrated in FIG. 7, GUI 700 may allow a user to select a data standard based on a value standard or a date standard. For example, radio buttons 701 and 702 may be provided to select a value standard or a date standard, as illustrated in FIG. 7. If the value standard radio button 701 is selected, the user may be allowed to enter the desired value based data standard. For example, check boxes 703-704 are provided to facilitate user selection of a data standard. On the other hand, if the date standard radio button 702 is selected, the user may be allowed to select check boxes 706-708 to select the appropriate date based data standard.

While radio buttons and check boxes are disclosed herein, one skilled in the art will recognize that embodiments of the invention are not limited to the particular implementation in GUI 700. More generally, any reasonable combination of text areas, drop down boxes, buttons, and the like may be implemented to facilitate user selection of a desired data standard. In some embodiment, the user may be allowed to select a plurality of data standards. For example, a user may select check boxes for gold and silver data standards. Accordingly, data meeting the definition of gold standard data and data meeting the definition of silver standard data may be displayed in the results of the query.

In one embodiment of the invention, user selection of a data standard may cause one or more query conditions to be added to a query created by a user. The added query conditions may be, for example, the conditions included in a data standard specification field 309 of the data abstraction model.

For example, after creating the exemplary query above, a user may select radio button 702 in GUI 700 to define a date based data standard and select check box 706 to indicate that only gold standard data is desired in the results of the query. Referring back to Field Z in FIG. 3, gold standard data is defined as data collected after the year 2000. Accordingly, the exemplary query may be modified as follows:

```
SELECT “Patient ID”, “Last Name”, “Test1”
FROM TABLE PATIENTS
WHERE
    Age > 50 AND HemoglobinTest > 30
    AND Date > 2000
```

Therefore, by including appropriate conditions from a data standard field specification into a query based on user selection of a data standard, the results of the query may be limited to data that falls within the purview of the identified data standard.

Similarly, if the user selected radio button 701 in GUI 700 to define a value based data standard, the appropriate conditions consistent with the user selection of a data standard may be included in the exemplary query. For example, if the user selected the gold standard, gold standard criteria 310 may be included in the query.

Query modification may be performed by the abstract query interface 146. For example, abstract query interface 146 may receive the exemplary query and a selection of a data standard. The abstract query interface 146 may then generate a modified abstract query comprising conditions of the exemplary query and conditions associated with a selected data standard. The conditions for the selected data standard may be derived from a data standard specification field 309.

One advantage of the features described above is that a researcher attempting to derive the most meaningful and reliable data may derive such data without the added complexity of determining the specific conditions for deriving such data and including those conditions each time during query composition. By providing an abstraction of data standards and allowing a user to simply select a particular desired data standard, query composition and the retrieval of desired results is made simpler and more efficient for a researcher. Furthermore, the tedious process of manually cleansing the data is obviated.

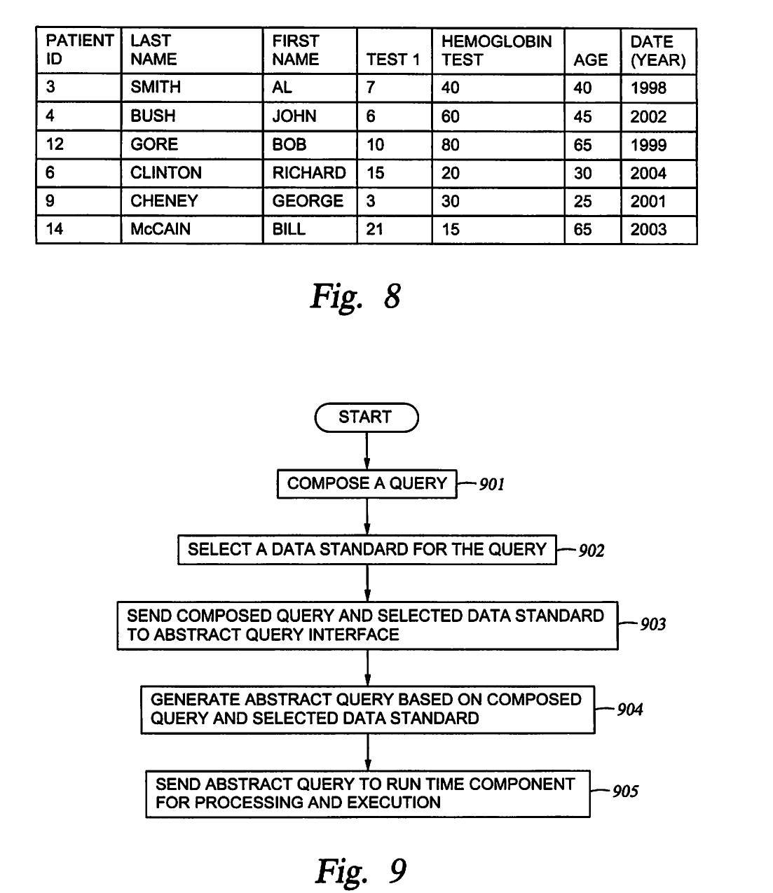

FIG. 8 illustrates an exemplary data table 800 against which the exemplary query described above may be run. Table 800 may include the relevant fields referenced by a query, for example, the exemplary query described above. For example, table 800 includes columns for the patient ID, last name, first name, test 1 value, hemoglobin test value, age, date, and the like. If the user selects a date based data standard and requests gold standard data in GUI 700, the query result may return records for patient ID 14 because the data for patient 14 was collected after the year 2000. The query result may display the patient ID, last name, and test 1 value as defined by the query.

If the user selects silver standard data, the query results may include the patient ID, last name, and test 1 value for patient 12. If the user selects both gold standard data and silver standard data, the query results may include results for patients 12 and 14. In some embodiments, selecting a lower quality data standard may display results for the lower quality data standard and results for any higher data standards. For example, selecting the silver data standard may generate results that are defined as silver standard and gold standard.

In one embodiment of the invention, a user may be prompted to specify a data standard for one or more fields of a query. A query may reference two or more fields, for example, test A and test B fields. In some instances, a researcher may want to derive gold standard data for test A. However, the researcher may be willing to consider silver standard data for test B, because, for example, test B data may not be crucial to the researchers study. In some embodiment, query program 114 may generate a GUI screen 700 for each of one or more fields of a query composed by a user, thereby allowing the user to specify a data standard for each field of the query.

In one embodiment of the invention, each field of database 127 may include its own associated data standard specification field 309 with customized data standard specification. For example, the conditions for gold standard data for test A may be different from the conditions for gold standard data for test B. Therefore, separate data standard specification fields 309 may be provided for each of the test A and test B fields. Referring back to FIG. 3, each field of database 127, for example, Field X, may map to its own customized value standard specification field and/or date standard specification field.

FIG. 9 illustrates an exemplary flow diagram of operations performed in the composition and execution of queries, according to an embodiment of the invention. The operations begin in step 901 with query composition. The query may be generated by a user using query program 114 to provide input to an application 140. Alternatively, the query may be generated by the application itself. In step 902, a data standard may be selected for the composed query. For example, a user may enter selections in a GUI screen 700 indicating a preference of a data standard.

In step 903, the composed query and the data standard selection may be sent to the abstract query interface 146. In step 904, the abstract query interface may generate an abstract query based on the composed query and the data standard selection. For example, abstract query interface 905 may insert conditions to the composed query based on a data standard specification field 309 to generate the abstract query. In step 905, the abstract query may be sent to the run time component for processing and execution.

### CONCLUSION

By allowing abstraction of data standards and providing a selection to define a data standard that may be applied to a query, embodiments of the invention allow a more efficient retrieval of desired data from a database. Furthermore, tedious manual data cleansing of query results is obviated by limiting the results of the query to data that comports with a specified data standard.

While the foregoing is directed to embodiments of the present invention, other and further embodiments of the invention may be devised without departing from the basic scope thereof, and the scope thereof is determined by the claims that follow.

What is claimed is:

1. A method for retrieving results from a database, comprising:
selecting a data standard to be applied to a query, wherein the data standard identifies a quality of data, the data standard being selected from at least two different data standards;
generating the query based on the selected data standard, wherein the query is configured to retrieve results that are in accordance with the selected data standard; and
executing the query.

2. The method of claim 1, wherein the query is generated according to input received via a graphical user interface (GUI) screen configured to facilitate query composition.

3. The method of claim 1, wherein selecting a data standard for the query comprises selecting the data standard in a GUI screen configured to display the at least two data standards and receive selection of the data standard.

4. The method of claim 1, further comprising selecting two or more data standards from the at least two data standards, and wherein the query is configured to retrieve results that are in accordance with the selected two or more data standards.

5. The method of claim 1, wherein the data standard comprises one or more conditions for determining the quality of data.

6. The method of claim 5, wherein, the query comprises the one or more conditions associated with the selected data standard.

7. The method of claim 5, wherein the one or more conditions determine the data standard based on one or more values stored in one or more fields of the database.

8. The method of claim 5, wherein the one or more conditions determine the data standard based on the time at which data is collected.

9. A computer readable medium containing a program which, when executed, performs an operation, comprising:
receiving a data standard selection to be applied to a query, wherein the data standard identifies a quality of data, the data standard being selected from at least two different data standards;
generating the query based on the selected data standard, wherein the query is configured to retrieve results that are in accordance with the selected data standard; and
executing the query.

10. The computer readable medium of claim 9, the operations further comprising receiving selections of two or more data standards from the at least two different data standards, and wherein the query is configured to retrieve results that are in accordance with the selected two or more data standards.

11. The computer readable medium of claim 9, wherein the data standard comprises one or more conditions for determining the quality of data.

12. The computer readable medium of claim 11, wherein, the query comprises the one or more conditions associated with the selected data standard.

13. The computer readable medium of claim 11, wherein the one or more conditions determine the data standard based on one or more values stored in one or more fields of the database.

14. The computer readable medium of claim 11, wherein the one or more conditions determine the data standard based on the time at which data is collected.

15. A system, comprising at least a memory and a processor and further comprising:
a data abstraction model providing a definition for each of a plurality of logical fields and a data standard definition for each of the logical fields, wherein the data standard definitions include at least two different data standard definitions defined on the basis of respective criteria; and
a run time component for generating, from an abstract query referencing at least one of the logical fields, a query consistent with a particular physical representation of data, wherein the query is configured to retrieve results that are consistent with the data standard definition corresponding to the at least one logical field referenced by the abstract query.

16. The system of claim 15, wherein each of the data standard definitions comprise one or more conditions for determining a quality of data.

17. The system of claim 16, wherein the query comprises conditions associated with the abstract query and the one or more conditions associated with the defined data standard for each of the logical fields.

18. The system of claim 16, wherein the one or more conditions are based on one or more values stored in one or more fields of a database.

19. The system of claim 16, wherein the one or more conditions are based on a time at which data is collected.

20. The system of claim 15, wherein the application is configured to provide a graphical user interface (GUI) screen configured to facilitate abstract query composition and data standard selection.
